(19) United States
(12) Patent Application Publication
(10) Pub. No.: US 2018/0255393 A1
(43) Pub. Date: Sep. 6, 2018

(54) Speaker Box

(71) Applicant: AAC Technologies Pte, Ltd., Singapore City (SG)

(72) Inventors: Chengliang Wang, Shenzhen (CN); Lin Liu, Shenzhen (CN); Fuhu Zhang, Shenzhen (CN); Shengrong Shi, Shenzhen (CN)

(21) Appl. No.: 15/646,739

(22) Filed: Jul. 11, 2017

(30) Foreign Application Priority Data
Mar. 1, 2017 (CN) 201720199523.2

(51) Int. Cl. H04R 1/28; H04R 1/02

(52) U.S. Cl. CPC H04R 1/2819; H04R 1/025; H04R 2499/11; H04R 2400/11; H04R 1/288

(57) ABSTRACT

A speaker box includes a lower cover; an upper cover engaging with the lower cover for forming an accommodating space; a speaker unit accommodated in the accommodating space; a front cavity formed by the speaker unit and the upper cover; a back cavity formed by the speaker unit, the lower cover and the upper cover; a clipping wall formed by the upper cover extending toward the lower cover till reaching the lower cover; an air-permeable isolating component fixed on and clamped to the clipping wall and dividing the back cavity into a first back cavity and a second back cavity communicated with the first back cavity. The speaker unit is located in the first back cavity, the second back cavity is filled with acoustic absorbing particles, and the air-permeable isolating component seals the acoustic absorbing particles inside the second back cavity.

### FIELD OF THE PRESENT DISCLOSURE

The present disclosure relates to the field of electroacoustic transducers, more particularly to a sound device for converting electric signals to audible sounds.

### DESCRIPTION OF RELATED ART

With the upcoming of mobile internet era, the number of smart mobile equipment keeps increasing. Among numerous mobile equipment, mobile phone is undoubtedly the most common and portable mobile terminal device. Currently, the mobile phone has a large variety of functions, including but not limited to high-quality music function; thereby speaker boxes used for sound playing are widely applied in current smart mobile equipment.

The speaker box of the related technology includes a lower cover, an upper cover engaging with the lower cover for forming an accommodating space, a speaker unit accommodated in the accommodating space, and a warding wall extending from the upper cover in the direction of the lower cover. The speaker unit and the upper cover cooperatively form a front cavity, the speaker unit, the lower cover and the upper cover circumvent to form a back cavity, the warding wall and the upper cover circumvent to form an auxiliary sound cavity, an air-permeable isolation plate is affixed to one side of the lower cover and parallel to the lower cover. The low frequency acoustic performance of the speaker box is improved by filling acoustic absorbing particles into the auxiliary sound cavity and thus forming a virtual sound cavity.

However, in the speaker box of related technology, the air-permeable isolation plate and the warding wall are connected by hot melt, a hot melt wall with a thickness of about 0.70 mm is needed to be installed on the warding wall to assist the hot melt process, at the same time, the air-permeable isolation plate is arranged parallel to the lower cover, a gap with a height of about 0.33 mm between it and the lower cover needs to be arranged as leakage of the back cavity. The hot melt wall and the gap structure of leakage occupy the volume of the auxiliary sound cavity which works as a virtual sound cavity, reducing the volume of the virtual sound cavity and affecting the low frequency acoustic performance of the speaker box.

Therefore it is necessary to provide an improved sound device for overcoming the above-mentioned disadvantages.

### BRIEF DESCRIPTION OF THE DRAWING

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an isometric view of a speaker box in accordance with an exemplary embodiment of the present disclosure.

FIG. 2 is an isometric and exploded view of the speaker box in FIG. 1.

FIG. 3 is a cross-sectional view of the speaker box, taken along line A-A in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

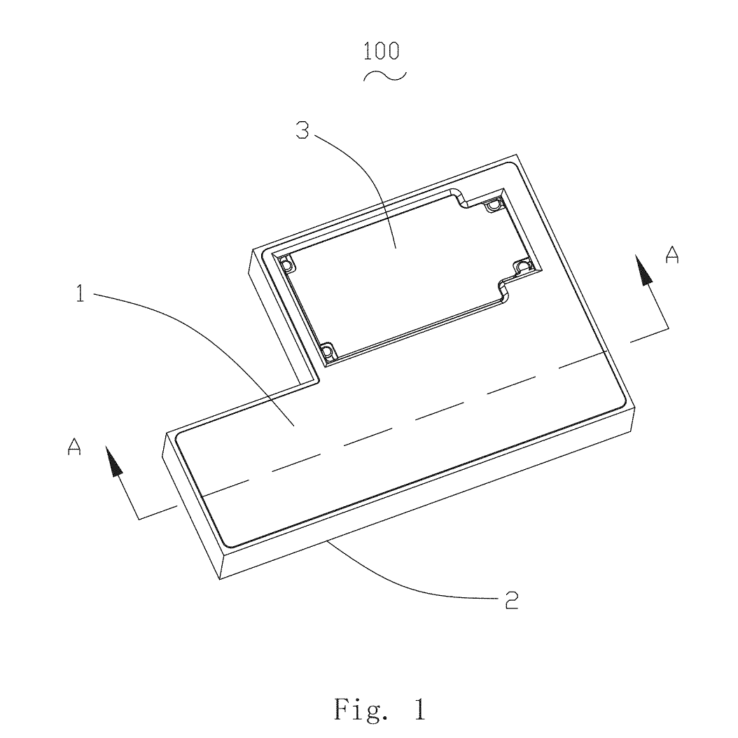

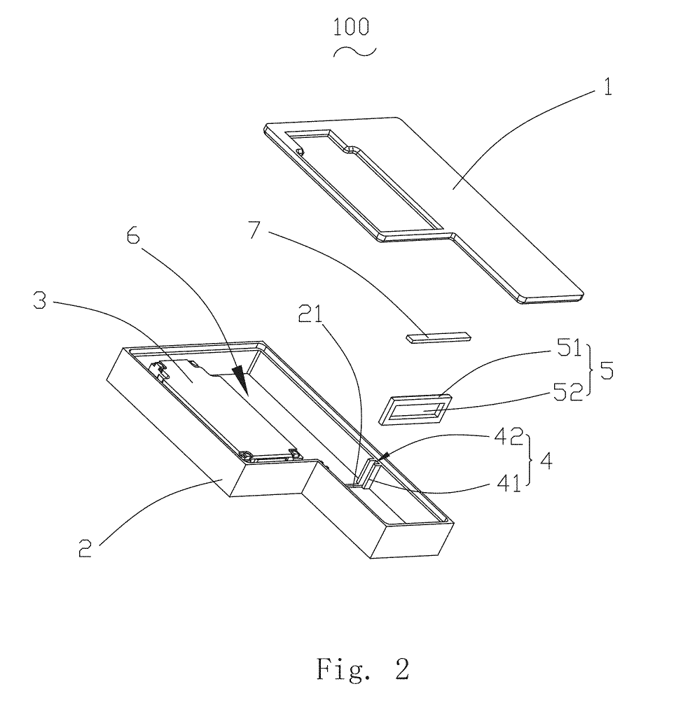

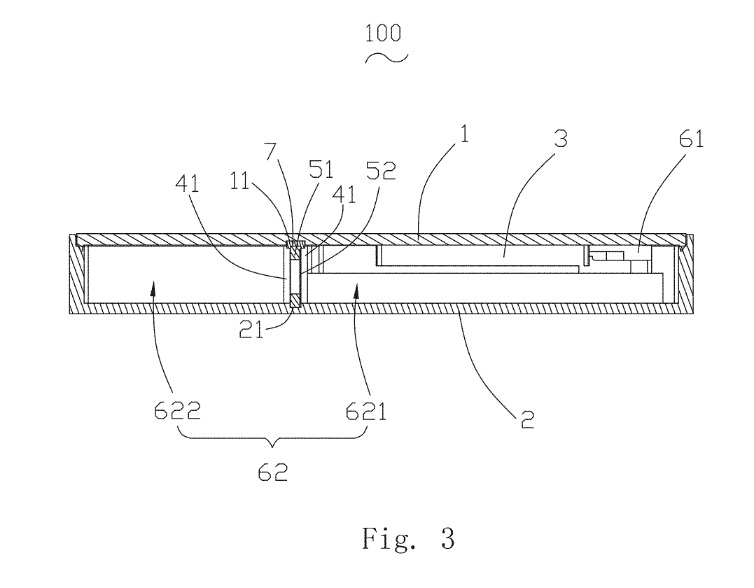

Referring to FIGS. 1-3, a speaker box 100 in accordance with an exemplary embodiment of the present disclosure, comprises a lower cover 1, an upper cover 2, a speaker unit 3, a clipping wall 4 and an air-permeable isolating component 5. The lower cover 1 and the upper cover 2 form together an accommodating space 6.

The speaker unit 3 is accommodated inside the accommodating space 6, the speaker unit 3 and the upper cover 2 cooperatively form a front cavity 61 to generate sound. The speaker unit 3, the lower cover 1 and the upper cover 2 cooperatively form a back cavity 62 to improve the low frequency acoustic performance.

The clipping wall 4 extends from the upper cover 2 toward the lower cover 1 and reaches the lower cover 1.

The air-permeable isolating component 5 is fixed on and clamped to the clipping wall 4 and divides together with the clipping wall 4 the back cavity 62 into a first back cavity 621 and a second back cavity 622. The first back cavity 621 and the second back cavity 622 are communicated with each other.

Concretely, the speaker unit 3 is located in the first back cavity 621. To improve the low frequency acoustic performance, the second back cavity 622 is filled with acoustic absorbing particles to form a virtual sound cavity. The air-permeable isolating component 5 seals the acoustic absorbing particles inside the second back cavity 622. In this embodiment, the sound absorbing particles are zeolite particles.

The air-permeable isolating component 5 includes a frame 51 and a net cloth 52 placed on the frame 51. The frame 51 is clamped to the clipping wall 4. Preferably, the frame 51 and the net cloth 52 are integrally formed by injection molding.

In this embodiment, two clipping walls 4 are installed oppositely to each other, wherein each of the clipping walls includes the part of the clipping wall itself 41 and a sliding groove 42 dented from the end of the part of the clipping wall itself 41 near the lower cover 1 against the other end. The width of the sliding groove 42 is equal to the thickness of the frame 51, and the frame 51 is inserted and locked inside the two sliding grooves 42, making the structure simple and easy to assembly.

The lower cover also includes a seal strip 7, wherein the seal strip 7 is pressed against the frame 51 and the clipping wall 4. Preferably, the lower cover 1 also includes a seal groove 11 dented toward the direction of being far from the upper cover 2, wherein the seal strip 7 is accommodated inside the seal groove 11. When the lower cover 1 is installed as a cover on the upper cover 2, the seal strip 7 is pressed against the frame 51 and the clipping wall 4 to be sealed, so as to prevent the acoustic absorbing particles of the second back cavity 622 from entering the first back cavity 621, improving the reliability of the speaker box 100. Optionally, in this embodiment, the seal strip 7 is made of rubber or sponge, of course, it can also be made of other materials.

Further, a fillister 52 is arranged on the upper cover 2 in the position opposite the frame 51, wherein the frame 51 is further locked inside the fillister 21. This structure can ensure that the acoustic absorbing particles will not leak from the air-permeable isolating component 5 after assembly.

To further increase the volume of the second back cavity 622, the net cloth 52 is placed on the side of the frame 51 close to the first back cavity 621. This structure can increase the volume of the virtual sound cavity in a greater extent, improving the acoustic frequency performance still more.

Compared with related technologies, the speaker box of the present utility model installs a clipping wall extending from the upper cover in the direction of the lower cover and a air-permeable isolating component clamped to the clipping wall, the clipping wall and the air-permeable isolating component divide together the back cavity into a first back cavity and a second back cavity, and the second back cavity is filled with acoustic absorbing particles, thus making it a virtual sound cavity, this structure is not only simple but also improves the low frequency performance of the speaker box; the connection of the first back cavity and the second back cavity is achieved in that the air-permeable isolating component is installed vertically on the lower cover, thus making the gap installed between the lower cover and the air-permeable isolating component for leakage unnecessary, that is, increasing the volume of the second back cavity; at the same time, this structure makes it possible that the hot melt wall can be lower, which also increases the volume of the second back cavity and improves the low frequency performance of the speaker box further.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box comprising:
a lower cover;
an upper cover engaging with the lower cover for forming an accommodating space;
a speaker unit accommodated in the accommodating space;
a front cavity formed by the speaker unit and the upper cover;
a back cavity formed by the speaker unit, the lower cover and the upper cover;
a clipping wall formed by the upper cover extending toward the lower cover till reaching the lower cover;
an air-permeable isolating component fixed on and clamped to the clipping wall and dividing the back cavity into a first back cavity and a second back cavity communicated with the first back cavity;
wherein
the speaker unit is located in the first back cavity, the second back cavity is filled with acoustic absorbing particles, and the air-permeable isolating component seals the acoustic absorbing particles inside the second back cavity.

2. The speaker box as described in claim 1, wherein the air-permeable isolating component includes a frame and a net cloth fixed on the frame, and the frame is clamped to the clipping wall.

3. The speaker box as described in claim 2, wherein the lower cover further includes a seal strip abutting against the frame and the clipping wall.

4. The speaker box as described in claim 3, wherein the lower cover further includes a seal groove for receiving the seal strip.

5. The speaker box as described in claim 3, wherein the seal strip is made of rubber or sponge.

6. The speaker box as described in claim 2 including two clipping walls, wherein each of the clipping walls includes a sliding groove.

7. The speaker box as described in claim 6, wherein a width of the sliding groove is equal to a thickness of the frame.

8. The speaker box as described in claim 6 further including a fillister arranged on the upper cover in the position opposite to the frame, wherein the frame is further locked inside the fillister.

9. The speaker box as described in claim 2, wherein the frame and the net cloth are integrally formed by injection molding.

10. The speaker box as described in claim 2, wherein the net cloth is placed on the side of the frame close to the first back cavity.
